(19) United States
(12) Patent Application Publication
(10) Pub. No.: US 2004/0164203 A1
(43) Pub. Date: Aug. 26, 2004

(54) Vertical take-off and landing aircraft

(76) Inventor: Charles Billiu, Harrison Twp, MI (US)

Correspondence Address: John G. Chupa, Esq., Law Offices of John Chupa and Associates, P.C., Suite 50, 28535 Orchard Lake Road, Farmington Hills, MI, 48334, US

(21) Appl. No.: 10/371,704

(22) Filed: Feb. 21, 2003

(51) Int. Cl. B64C 3/00

(52) U.S. Cl. 244/35 R

(57) ABSTRACT

An impeller (16) driven ring wing (12) aircraft (10) whose lifting forces are augmented by the release of jets of air (113) from Coanda slots (42) disposed around the exterior edge. (32) of the ring wing (12). These jets of air (113) entrain the air passing by the ring wing (12) downwardly to act as thrust to lift the aircraft (10).

### FIELD OF THE INVENTION

The present invention generally relates to an aircraft and to a method for making an aircraft capable of vertical flight and more particularly, to an aircraft which utilizes a ring shaped wing having Coanda slots and an impeller to generate sufficient lift to permit vertical take-off and landing capability and flight characteristics comparable to a conventional helicopter in a safe and cost-effective manner, but without the disadvantages of a rotor.

### BACKGROUND OF THE INVENTION

Conventional airplanes and aircraft use wings or airfoils to produce lift. Bernoulli's theorem teaches that an airplane flies because the air flowing over the top of the wing travels farther than air under the wing and therefore is less dense. This causes the wing to rise to balance the pressures. As shown in FIG. 1, the lift generated by the balancing of air pressures is supplemented by the force of the flow of air 2 passing by the wing or airfoil 1 and which follows the shape or contour 3 of the airfoil 1. The flow of air 2 following contour 3 exerts a force or vector 4 which is in substantially the same direction as the shape 3 of the airfoil 1. It should be appreciated that force vector 4 is comprised of two component force vectors 4x, 4z and by following the contour 3 of airfoil 1, the “horizontal” vector 4x comprises the majority of the force vector 4 while the “vertical” or thrust vector 4z makes up the remainder of the force of the flow of air 2 over the airfoil 1. As will be discussed in greater detail below, the present invention redirects the flow of air to increase the amount of force provided in the direction of vector 4z.

In fixed wing aircraft (i.e., airplanes), air is passed around the wings by accelerating the entire aircraft until the pressure differential between the lower and upper surfaces of the wings and the force due to the flow of air in the direction of vector 4z creates enough lifting force to cause the airplane to fly (i.e., where the lift provided by the wings overcomes the force of gravity exerted upon the airplane). Helicopters and certain other aircraft have been developed which are capable of substantially vertical flight by generating lifting forces which are greater than the weight of the aircraft while remaining in the same position relative to the ground. By rapidly rotating relatively large airfoils or “blades” about a central axis, conventional helicopters force large volumes of air over and under the airfoils to generate sufficient lift to permit vertical take-off. Conventional helicopters, however, suffer from certain drawbacks. Particularly, helicopters are very complicated machines which have numerous moving parts which must each function properly in order to safely lift the helicopter from the ground. For example and without limitation, conventional helicopters have transmissions, thrust bearings, swash plates, and other complicated linkages which all have the potential to fail and render the helicopter unsafe to fly. Additionally, maintenance upon all of these components is costly and time consuming.

Furthermore, the blades/wings of conventional helicopters and airplanes are coupled to the rest of the aircraft as cantilevered beams. That is, these wings are only supported at one end and all of the lifting force exerted upon these wings is transferred to the joint coupling the wing to the aircraft. Due to the relative weakness inherent in cantilevered beams such as conventional helicopter blades (and airplane wings) there is a limit to the amount of lifting force a blade/wing may produce.

Conventional helicopters also have the disadvantage that the rotatable blades of the primary rotor must be very long to generate sufficient lift to allow the helicopter to fly and take-off. These blades extend a relatively large distance out from the body or fuselage of the vehicle and are rotated at a very high rate of speed. The inherent danger of these rapidly spinning blades is generally described as “rotor hazard” and any object or person which finds itself within the circumference of the spinning rotor blades will cause extreme damage to both the object and the helicopter.

Another drawback of conventional helicopters is that the rotation of the blades when the helicopter lands creates a relatively forceful stream of air or “prop wash” which is directed downward from the blades. This prop wash undesirably creates a small “wind storm” which blows debris (e.g., sand, leaves, and substantially any other loose object) all around the helicopter as it lands.

Furthermore, in order to increase the lift generated by conventional airfoils, articulatable louvers or “flaps” may be disposed upon the edges of the airfoil in order to vary the geometry of the airfoil and thereby alter the surface areas of the airfoil to vary the pressure differential between the upper and lower surfaces and redirect the airflow to increase the thrust vector (e.g., in the direction of vector 4z). These airfoils having articulatable flaps, however, have numerous moving parts which undesirably increase the cost and complexity of the wing and increase the likelihood that a mechanical failure will render the vehicle unable to fly.

These and other needs are addressed by the present invention as is more fully delineated below.

### SUMMARY OF THE INVENTION

It is a first non-limiting advantage of the present invention to provide an aircraft which overcomes some or all of the previously delineated drawbacks of prior aircraft.

It is a second non-limiting advantage of the present invention to provide an aircraft which overcomes some or all of the previously delineated drawbacks of prior aircraft and which, by way of example and without limitation, is capable of vertical take-off and landing while concomitantly reducing the number of moving parts associated with the generation of lift.

It is a third non-limiting advantage of the present invention to provide an aircraft which overcomes some or all of the previously delineated drawbacks of prior aircraft and which, by way of example and without limitation, has a ring shaped wing with Coanda slots along its exterior edge.

It is a fourth advantage of the present invention to provide an aircraft. Particularly, the aircraft comprises a an airfoil which is generally ring shaped to form and aperture, wherein said airfoil includes a plurality of Coanda slots disposed along an external edge; and an impeller which is rotatably coupled to a source of torque, said impeller being disposed within said aperture.

It is a fifth advantage of the present invention to provide an aircraft. Particularly, the aircraft comprises a body having a central portion and a pair of cargo portions which are coupled to said central portion on opposing sides; an engine having an output shaft, wherein said engine is disposed within said central portion and said output shaft is directed up from the top of said body along a centerline; an impeller which is coupled to said output shaft, wherein rotation of said output shaft is effective to cause said impeller to force air outward from said centerline; a ring wing having a interior edge which is in the shape of a circle and defines an aperture and an exterior edge which defines an outer periphery of said ring wing, said airfoil being coupled to said body wherein said impeller is disposed within said aperture and said outwardly forced air is directed above and below said ring wing to create a first lifting force; a plurality of equally spaced Coanda slots which are disposed within said ring wing along said exterior edge, wherein each of said plurality of Coanda slots is coupled to a manifold through a separate valve assembly; and a controller which is disposed within said central portion and which is operatively coupled to said engine and said valve assembly, wherein said controller selectively opens said valve assemblies to emit an amount of gas from said plurality of Coanda slots and divert said outwardly forced air downward to create a second lifting force.

It is a sixth advantage of the present invention, a method is provided for making an aircraft capable of vertical flight. The method comprises the steps of providing a body with an engine having an output shaft which is directed upwardly; rotatably couplings an impeller to said output shaft upon the top of said body, wherein said impeller may be rotated to create a wash of air; providing a ring wing having interior edges which define a central aperture and exterior edges which define an outer edge; forming segmented Coanda slots along said outer edge of a ring wing, wherein each of said Coanda slots has a valve assembly which may be selectively opened and closed; coupling said ring wing to said body wherein said impeller is located within said central aperture, thereby causing said ring wing to be disposed within said wash of air; causing said impeller to rapidly rotate and create said wash of air which passes as a laminar flow having a certain boundary layer above and below said ring wing to create lift; and causing said Coanda slots to discharge jets of gas at a certain velocity to redirect said laminar flowing air passing said ring wing to create additional lift.

These and other features, aspects, and advantages of the present invention will become apparent to those of ordinary skill in the art from a reading of the following detailed description of the preferred embodiment of the invention and by reference to the following drawings.

### BRIEF DESCRIPTION OF THE DRAWINGS

FIG. 1 is a diagrammatic view of the flow of air over a conventional airfoil.

FIG. 2 is a perspective view of an aircraft which is made in accordance with the teachings of the preferred embodiment of the invention.

FIG. 3 is a partially exploded diagrammatic perspective view of the aircraft which is shown in FIG. 2.

FIG. 4 is a diagrammatic front sectional view of the aircraft which is shown in FIGS. 2 and 3.

FIG. 4A is a top sectional view of the segmented Coanda slots of the aircraft shown in FIG. 4.

FIG. 5 is a side view of the aircraft which is shown in FIGS. 2-4.

FIG. 6 is a partial side sectional view of the airfoil assembly of the aircraft shown in FIGS. 2-5.

FIG. 6A is an enlarged view of a portion of FIG. 6 depicting the Coanda slot and the Coanda effect.

FIG. 7 is a diagram of interconnection of the controller with the other components of the aircraft which is shown in FIGS. 2-6A.

FIG. 8 is a diagram of the control schematics of one non-limiting embodiment of the invention shown in FIGS. 2-7.

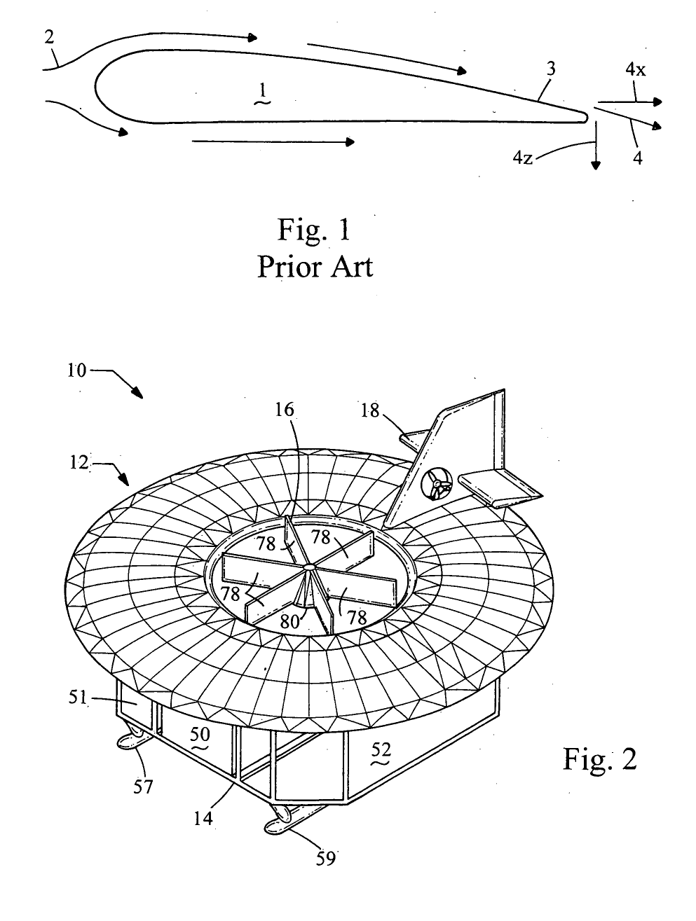

### DETAILED DESCRIPTION OF THE PREFERRED EMBODIMENT OF THE INVENTION

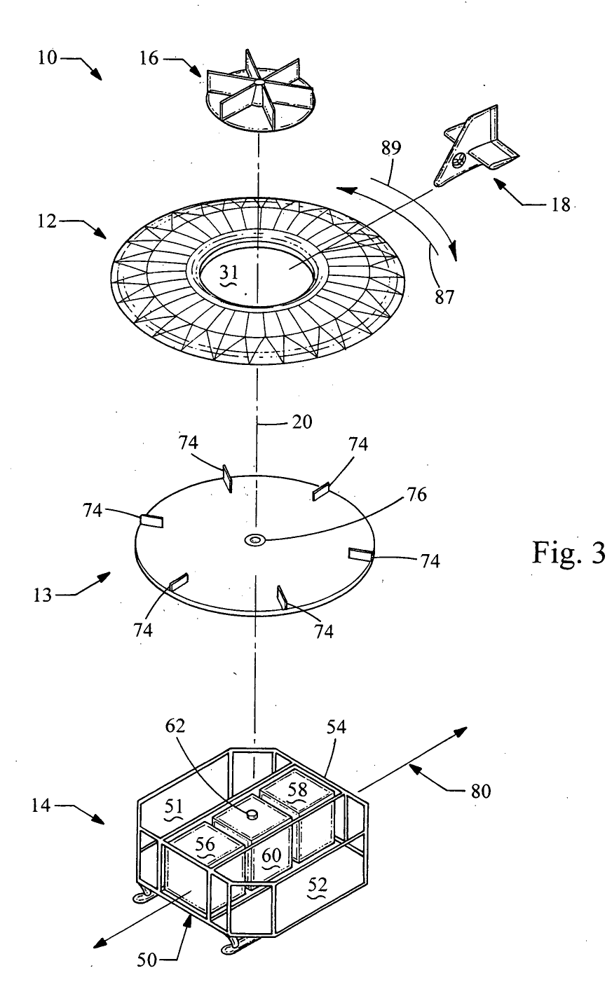

Referring now to FIGS. 2 and 3, there is shown an aircraft 10 which is made in accordance with the teachings of the preferred embodiment of the invention. Aircraft 10 may be generally described as a vertical take-off and landing vehicle having a ring shaped airfoil portion or ring wing 12, a body portion 14, and an impeller 16.

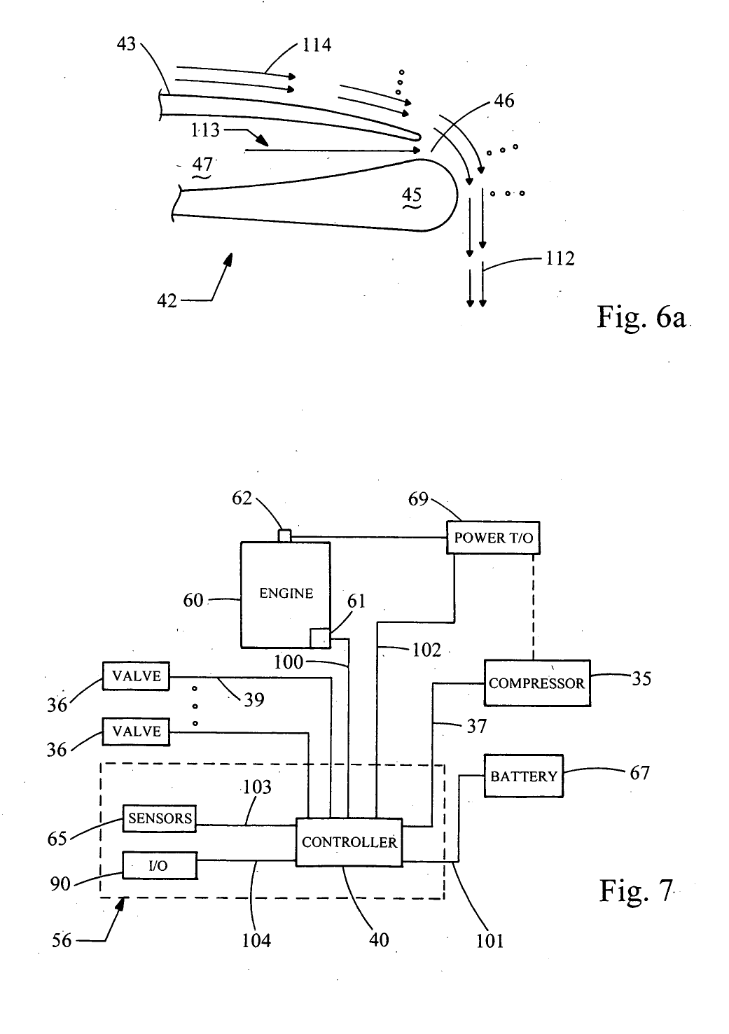

Particularly, airfoil portion 12 is generally formed as a “ring wing” wherein an airfoil-shaped cross section (such as the cross section shown in FIG. 6) is revolved about a central axis, such as centerline 20 thereby forming a ring wing 12 having a circular gap or aperture 31 formed within the center of the ring wing 12 (i.e., aperture 31 is bounded by the interior edge 30 of airfoil 12). In this manner, the entire interior edge 30 of the ring wing 12 is directed towards of “faces” the centerline 20 while exterior edge 32 faces outwardly. In the preferred embodiment of the invention, the ring wing 12 is oriented and mounted upon the aircraft 10 having a pitch angle between 50-75 percent of the allowed pitch before wing stall.

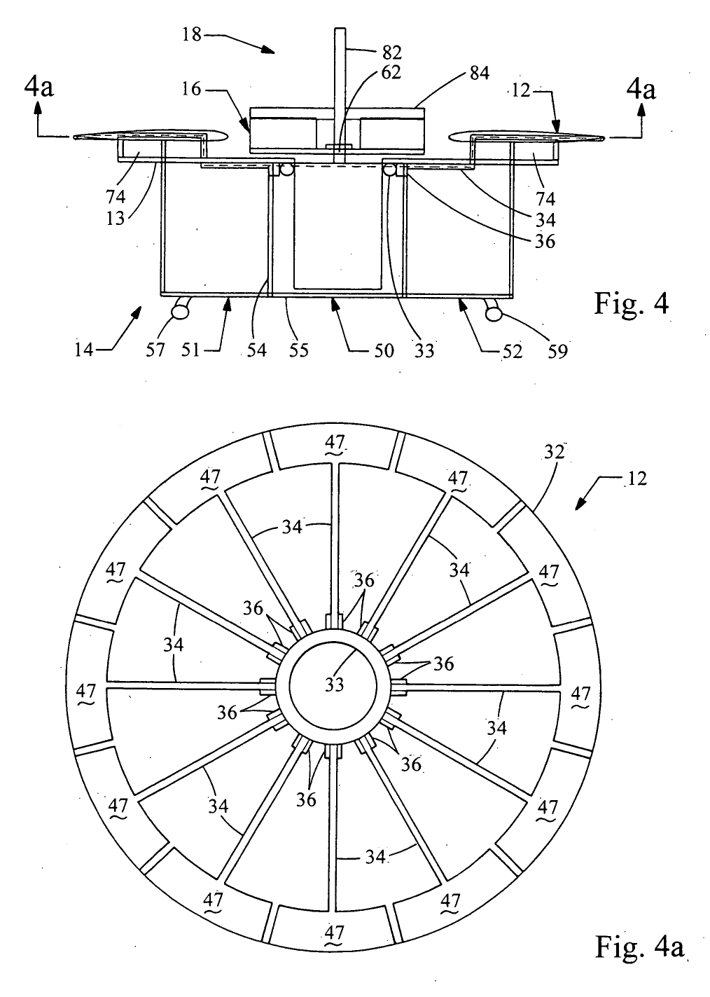

It should be appreciated that a cross section of ring wing 12 is shaped substantially the same as a conventional aircraft wing or airfoil with the following exceptions. Namely, the interior of the ring wing 12, as shown best in FIGS. 4A and 6, includes a plurality of conduits 34 which interconnect the body portion 14 to the interior area of the ring wing 12. Additionally, the exterior edge 32 of ring wing 12 includes a plurality of equally spaced or “segmented” Coanda slots 42. Coanda slots 42 are relatively small gaps 46 which are fluidly (i.e., pneumatically) coupled via a plenum 47 to one of the conduits 34.

Each of the conduits 34 are connected to a generally hollow manifold 33, through a valve assembly 36. As shown in FIG. 4A, a unique valve assembly 36 connects manifold 33 to the conduits 34. In the preferred embodiment of the invention, manifold 33 is generally circular in shape and each valve assembly 36 and its corresponding conduit 34 radially extend from manifold 33 toward the exterior edge 32 of ring wing 12. Valve assemblies 36, in the preferred embodiment of the invention, are electronically actuated valves which may be selectively opened and closed upon receipt of an electric signal. In one non-limiting embodiment of the invention, twelve valve assemblies 36 are equally spaced around the manifold 33.

Manifold 33 is further connected to a source of compressed gas, such as compressor 35. In this manner, manifold 33 receives pressurized gas from source 35 and in one non-limiting embodiment of the invention, source 35 is effective to maintain a relatively constant gas pressure within manifold of approximately forty to fifty p.s.i.

Coanda slots 42 are formed by terminating the bottom surface 44 of ring wing 12 to form a generally rounded edge 45 which approaches, but does not abut the terminating edge of the top surface 43, thereby forming gap or slot 46. As shown in FIG. 4A, each conduit 34 connects with an enlarged area or plenum portion 47 which, in the preferred embodiment of the invention, is effective to substantially eliminate any sporadic emission of pressurized gas from gap 46 (e.g., pulsing) and to reduce the pressure of the gas emitted from manifold 33 to approximately zero to five p.s.i. out of the corresponding gap 46. It should be appreciated that each gap 46 traverses substantially the entire length of the exterior side of the plenum 47.

In the preferred embodiment of the invention, the outer diameter of ring wing 12 is approximately 12 feet (3.66 meters) and contains twelve separated Coanda slots 42, while the inner diameter of ring wing 12 is approximately 4.5 feet in diameter (approximately 1.37 meters). It should be appreciated that each Coanda slot 42 has its own separate valve assembly 36 and that each Coanda slot 42 may be selectively and separately controlled to discharge jets of gas from manifold 33. In this manner, compressed gas received from source 35 and contained within manifold 33 may be selectively emitted out of the exterior edge 32 of the ring wing 12 by opening valves 36.

Referring now to FIGS. 3 and 4, aircraft 10 further includes a fuselage or body portion 14. Body 14 is generally divided into three sections, a first centralized equipment portion 50 and a pair of cargo portions 51, 52 which are disposed on opposing sides of central portion 50. Portions 50-52 are coupled to a structural frame 54 and a bottom plate 55. In one non-limiting embodiment of the invention, frame 54 is formed from tubular members to reduce weight while maintaining support and rigidity. In the preferred embodiment of the invention, a pair of support members or “landing skids” 57, 59 are fixedly coupled to the underside of bottom plate 55 to support the aircraft 10 on the ground.

Center portion 50 includes an avionics portion 56, auxiliary systems portion 58 and a portion which contains the engine 60, the manifold 33 and the valve assemblies 36. Engine 60 is disposed within portion 50 to align the output shaft 62 of engine 60 with the centerline 20. For example and without limitation, engine 60 may be a turbo-charged six cylinder internal combustion engine. In another non-limiting embodiment of the invention, engine 60 is an Erickson square piston type engine to reduce the amount of noise generated by the aircraft 10.

As best shown in FIGS. 6 and 7, avionics portion 56 includes conventional aircraft controls and sensors 65 (e.g., wind speed sensors, compass, artificial horizon) which are coupled to a computerized numerical control or controller 40. Portion 56 further includes a gyro assembly, such as a fixed position gyro 130, which is coupled to controller 40 by a bus 131 (e.g., an RS232 connection). It should be appreciated that gyro 130 measures the distance from level and direction of the aircraft 10 and transmits this information digitally to the controller 40 through the bus 131. Controller 40 is further coupled to source 35 and electronic valves 36 through buses 37, 39 respectively and is effective to selectively increase and decrease the pressure within manifold 33 (e.g., upon receipt of a signal from a pressure sensor (not shown) disposed within manifold 33) and to selectively open and close valves 36. That is, controller 40 selectively sources electrical energy from battery 67 to each valve 36 in order to open or close that valve 36.

In the preferred embodiment of the invention, auxiliary systems portion 58 includes additional systems and components which supplement the engine 60 and avionics portion 56 to enable the aircraft 10 to fly. In the preferred embodiment of the invention, portion 58 may include fuel tanks for engine 60, an air compressor or engine exhaust turbine (i.e., source of pressurized gas 35) which supplies compressed gas into manifold 33, a source of electrical energy, such as a battery 67, and a torque take-off assembly 69 which receives a portion of the torque from engine 60 and transmits this torque to another assembly, such as a tail rotor. In other non-limiting embodiments, portion 58 includes a cooling fan(s) and/or a radiator system which is coupled to engine 60 to assist in cooling engine 60. In another non-limiting embodiment, portion 58, may also include an electrical generator which is coupled to engine 60 or take-off assembly 69 to convert the rotational energy of engine 60 into electrical energy. This electrical energy may be supplied to battery 67 and/or sourced to substantially any other electrical device. In this manner, aircraft 10 may operate as an airmobile electrical generator.

In the preferred embodiment of the invention, cargo portions 51, 52 are storage compartments which are enclosed in relatively thin (i.e., lightweight) exterior walls 70. These walls 70 include access doors or panels 72 which permit an individual to gain access to the generally hollow interior cargo area of portions 51, 52. In alternative embodiments of the invention, portions 51, 52 may include substantially any piece of equipment or cargo carrying means. For example and without limitation, portion 51, 52 may be adapted to bear stretchers or litters to transport the injured (i.e., a pair of stretchers may be selectively secured to the plate 55 to evacuate an injured person) Alternatively, portions 51, 52 may contain seats for transporting individuals, electronic equipment such as cameras, and/or weaponry. It should further be appreciated that aircraft 10 may include various cargo sling anchors which may be fixedly coupled to the frame 54 or plate 55 to permit additional cargo carrying flexibility. In other non-limiting embodiments, portions 51, 52 may be modular in nature to enable relatively quick connection and disconnection from frame 54 and central portion 50. In this manner, different components or cargo carrying devices may be selectively inserted/removed from a single aircraft 10 to increase the versatility of that aircraft 10.

Aircraft 10 further includes a top plate or base plate 13 which is fixedly coupled to the top of body portion 14 by conventional means (e.g., via welding and/or mechanical fasteners). In the preferred embodiment of the invention, plate 13 is a circular disk having a diameter which is slightly smaller than the outer diameter of ring wing 12. Plate 13 includes an aperture 76 at its center-point, wherein aperture 76 is sized to permit output shaft 62 to protrude through (i.e., aperture 76 is also aligned with centerline 20). Top plate 13 further includes a plurality of evenly spaced vertical support members or struts 74. Struts 74 are radially spaced around centerline 20 and are disposed in close proximity to the outer edge of plate 13. Each strut 74 projects orthogonally from top plate 13 and is coupled to the bottom surface 44 of the ring wing 12. That is, the upper surface of each strut 74 is contoured to follow the airfoil-shape of the wing 12. Struts 74 cooperate to rigidly couple the lift producing ring wing 12 to the body 14 of aircraft 10. It should be appreciated that struts 74 are oriented upon plate 13 so that a relatively small surface area or “low profile” is presented to the wind/air passed under the ring wing 12 which generates lift to reduce wind resistance or drag. In the preferred embodiment of the invention, at least one strut 74 has an aperture or hollow (not shown) which permits conduits 34, busses 39 and other equipment to gain access to the interior of ring wing 12 (i.e., an aperture is formed in the ring wing 12 where that strut 74 is coupled to the ring wing 12).

Aircraft 10 further includes an impeller 16 which is rotatable coupled to the output shaft 62 of engine 60. Impeller 16 is disposed concentric to ring wing 12 within aperture 31. Particularly, impeller 16 includes a plurality of straight vanes 78 which are fixedly coupled to and project from a central hub 80. Hub 80 is fixedly coupled to output shaft 62 effective to receive torque from engine 60 to cause impeller 16 to rotate about centerline 20. Impeller 16 is positioned within aperture 31 to cause ring wing 12 to be within the air stream or “wash” of air which is created by the rotation of impeller 16.

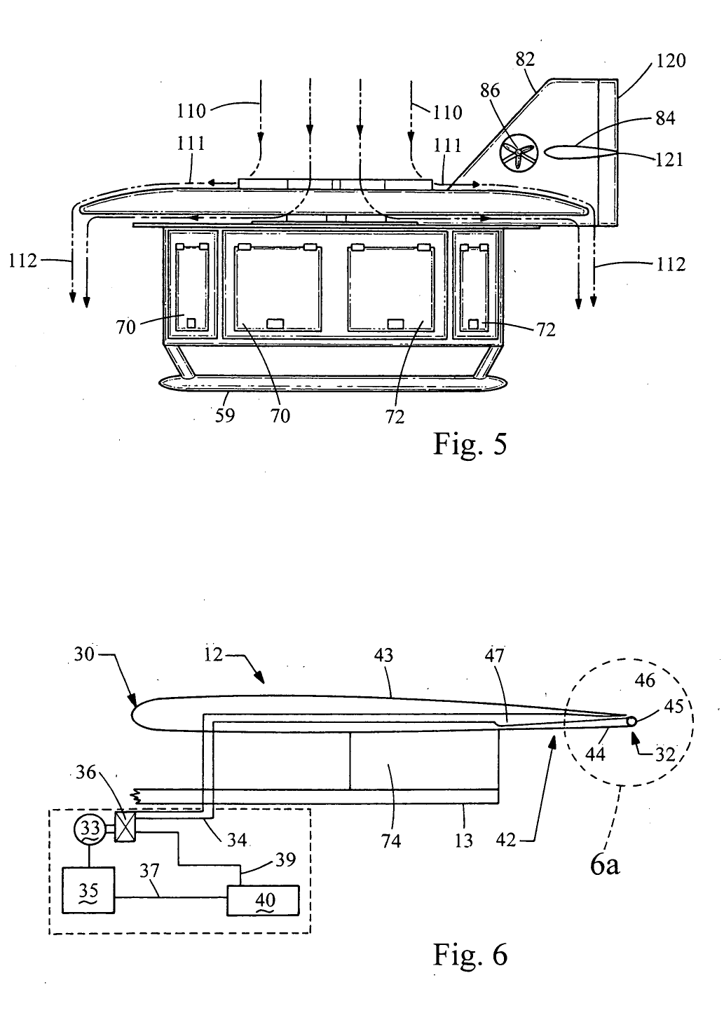

In the preferred embodiment of the invention, aircraft 10 further includes a tail portion 18 which is operatively coupled to the body 14 of aircraft 10. Namely, tail portion 18 is disposed within a gap formed in ring wing 12 which receives tail portion 18 and permits access to body 14 (e.g., to top plate 13) along the longitudinal axis of symmetry 80 of aircraft 10. That is, tail 18 is disposed in the “middle” of center portion 50. In the preferred embodiment of the invention, tail portion 18 is formed from a vertical stabilizer 82 and a horizontal stabilizer 84. As best shown in FIG. 5, tail portion 18 further includes a small rotor or propeller 86 which is rotatably mounted within vertical stabilizer 82. Propeller 86 is driven by a conventional driveline (not shown) which is operatively coupled to engine 60 by power take-off assembly 69 or by other conventional means. Propeller 86 is selectively rotated to produce an amount of torque in the direction opposite to the torque produced by the rotation of impeller 16. That is, if the rotation of impeller 16 causes the body 14 to begin rotating in the direction of arrow 87, propeller 86 produces a resistive force in the direction of arrow 89 to counteract this rotation. In the preferred embodiment of the invention, horizontal stabilizer 84 is disposed upon and coupled to the vertical stabilizer 82 where the horizontal stabilizer is within the slip stream or wash of propeller 86.

In one non-limiting embodiment of the invention, each of the stabilizers 82, 84 include conventional rudder 120 or elevator 121 mechanisms which are coupled to conventional electric servo assemblies 122, 123 which selectively move the rudder 120 and elevators 121 to assist in the control of aircraft 10. In other non-limiting embodiments of the invention, tail portion 18 is coupled to the top surface 43 of ring wing 12.

Controller 40 is communicatively coupled to engine 60 via bus 100 in a conventional manner, effective to permit controller 40 to selectively vary the rotational velocity of engine 60 (e.g., by manipulating the fuel throttle 61 of engine 60 by an electric servo assembly 124).

In operation, controller 40 transmits a signal upon bus 100 to engine 60 which directs engine 60 to begin rotating impeller 16 (and concomitantly propeller 86). As will be discussed in greater detail below, aircraft 10 uses three types of lifting forces to allow it to fly.

First, the rapid rotation of impeller 16 operates to direct or “pull” ambient air downward in the direction of arrows 110. This rapid suction of air toward the top of aircraft 10 creates a vacuum effect which generates a first lifting force upon the aircraft 10.

Secondly, the placement of the ring wing 12 within the wash of impeller 16 creates a rapid flow of air in the directions of arrows 111 (i.e., from the interior edge 30 of ring wing 12 to the exterior edge 32 of ring wing 12). The placement of ring wing 12 within the wash of the rotating impeller 16 causes a large volume of air to be directed across the airfoil-shaped ring wing 12 thereby creating a second lifting force which includes the thrust 4z from the shape of the airfoil. That is, the rapid flow of air above and below the upper and lower surfaces 43, 44 of ring wing 12 operates to generate lift in a substantially identical manner to a conventional airplane's wing 1.

Lastly, and as best shown in FIG. 6A, the release of a jet of gas 113 out of the exterior gaps 46 of the Coanda slots 42 formed in the exterior edge 32 causes the laminar flow of air 114 passing over the top surface 43 of the airfoil to be directed in the direction of arrows 112 (i.e., downward) to create a third lifting force. The jet of gas 113 creates a Coanda effect in which the flow of air normally following in the direction of vector 4 is redirected by the jet of gas 113 in a downward direction to increase the thrust vector 4z provided by the airfoil. The Coanda effect from the emission of jets of gas from each plenum 47 and gap or slot 46 greatly increases the lifting force of the ring wing 12, as the laminar flow 114 which is directed substantially outward (e.g., vector 4x) is redirected “down” to act as supplemental lift or thrust 4z. The laminar flow of air 114 over airfoil is bonded to the airfoil by a low-pressure boundary layer. The jet of gas 113 emitted from the Coanda slots 42 effectively extend the boundary layer by augmenting and diverting the laminar flow 114 into “downward” flow of air 112 as thrust 4z. The controller 40 selectively controls the length of the boundary layer arching over the circular lip 45 by varying the velocity (i.e., the pressure) of the emitted jet 113, thereby controlling the amount of thrust 112 provided by the Coanda slots 42. Controller 12 does this by selectively controlling both the opening of valves 36 and the pressure which is resident within manifold 33.

It should be appreciated that segmenting and separating the Coanda slots 42 around the periphery of the ring wing 12 and providing a separately controllable valve 36 to each Coanda slot 42 enables controller 40 to selectively vary the velocity of the jet of air 113 being emitted from an individual Coanda slot 42 to control the trim (e.g., pitch and roll) of the aircraft 10 and maintain a relatively level flight path. For example and without limitation, controller 40 may temporarily and selectively direct the Coanda slots 42 disposed in the front of aircraft 10 to emit a lower pressure/velocity jet of air 113 to reduce the amount of thrust and/or to increase the jet of air 113 directed out of a Coanda slot 42 disposed in the rear of the aircraft 10 in order to cause the entire aircraft to pitch “forward” where the front or “nose” of the aircraft 10 dips while the rear or “tail” is raised.

Once the desired pitch is achieved (i.e., once controller 40 receives signals from sensors 65, such as an artificial horizon sensor, and/or from fixed position gyro 130, that the desired pitch is achieved), controller 40 may then direct all of the Coanda slots 42 to emit jets of gas 113 having the same pressure/velocity in order to cause the “downward” thrust 112 (in addition to the other lifting forces caused by the airflows 110, 111) to propel the aircraft 10 forward. By the selective manipulation of certain Coanda slots 42 to achieve this attitude control via “thrust vectoring”, the controller 40 includes as stored program control a conventional vector analysis program to determine which Coanda slots 42 are to be operated (i.e., which valves 36 are to opened and by what degree).

Controller 40 may selectively close all of the valves 36 when the aircraft 10 is approaching the ground (i.e., when landing) to reduce the amount of thrust being directed straight down, thereby substantially reducing the “prop wash” effect as the aircraft 10 lands. To this end, aircraft 10 relies upon the lifting forces provided by the air-foil shaped ring wing 12.

In the preferred embodiment of the invention, aircraft 10 is “unmanned”, that is there is not a pilot in the conventional sense residing within the aircraft 10 as it is operated. Instead, controller 40 is used to control the flight characteristics of the aircraft 10 and a user provides controller 40 these desired characteristics through an input/output portion 90 which is coupled to controller 40 via bus 104. Input/output portion 90, in the preferred embodiment of the invention comprises a radio frequency transmitter and receiver (or similar device) which receives flight control signals from a user through a conventional remote control unit. Controller 40 receives these control signals from portion 90 and manipulates the throttle of engine 60, the pressure of the gas jets 113 being emitted from each of the segmented Coanda slots 42, and in one non-limiting embodiment by changing the angle of a rudder 120 disposed upon vertical stabilizer 82. Additionally, controller 40 transmits digital information received from data collection equipment, such as data from a camera and/or sensors 65, back to the user through input/output portion 90 to further facilitate the control of aircraft 10.

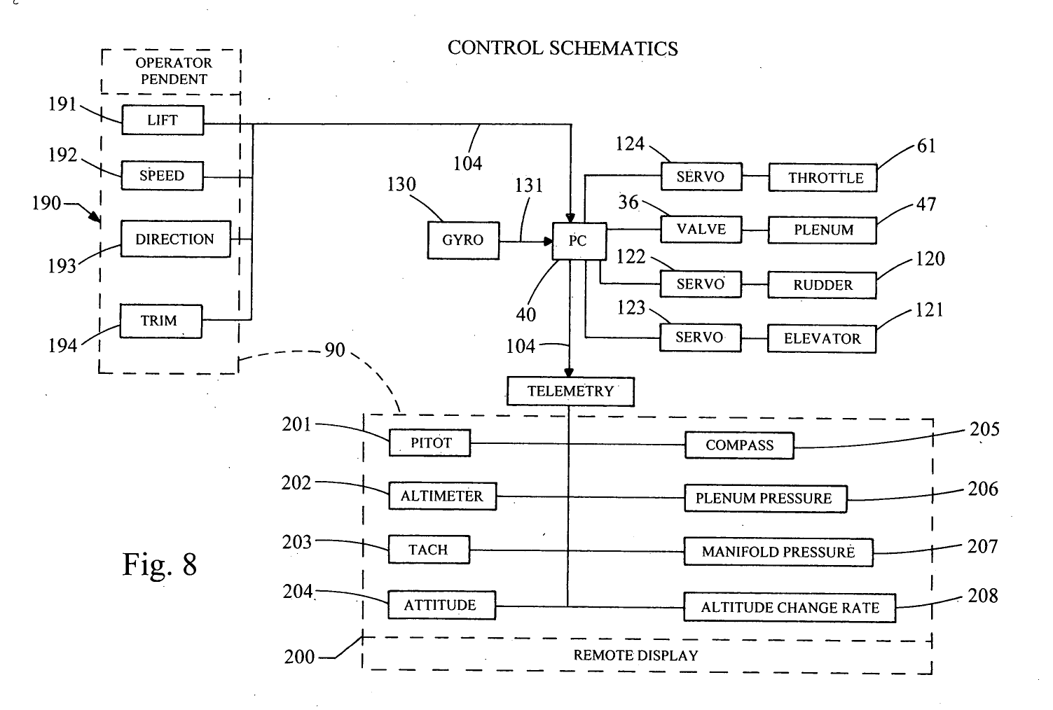

As shown in FIG. 8, in one non-limiting embodiment of the invention, input/output device or portion 90 may be a control pendant which is physically tethered to aircraft 10 and controller 40 by an extended and reinforced bus 104 which permits a user to maintain physical as well as visual contact with the aircraft 10 as the aircraft 10 is piloted. Pendent 90, in this non-limiting embodiment, includes user manipulatable controls 190 allow the user to selective or choose the desired lift 191, speed 192, direction 193, and trim 194 of the aircraft 10. For example and without limitation, each of these controls 190 may be a variable potentiometer or dial which the user turns to direct the aircraft 10 by sending electric signals through bus 104 (or via radio frequency signals) into controller 40. Controller 40 may, in turn, provide certain telemetry data to the user to assist in the control of the aircraft 10. For example and without limitation, input/output portion 90 may further include a display assembly 200 which receives data signals from controller 40 (and through sensors 65) to show the airspeed 201, altitude 202, engine speed 203 attitude 204, compass heading 205, pressures in the plenum 206 and/or manifold 207, and the altitude change rate 208. This telemetry data 201-208 may be displayed in substantially any configuration or format to assist the user in operating the aircraft 10 through controls 191-194.

In other non-limiting embodiments, controller 40 of aircraft 10 may be programmed to execute a pre-defined flight plan. That is, a user may input map coordinates, altitudes, velocities, et cetera into controller 40 to cause aircraft 10 to automatically fly the programmed route. In this manner, a search pattern or routine may be conducted without continuous manipulation of controls by a user as the aircraft 10 is flying.

It is to be understood that the invention is not limited to the exact construction which have been described above, but that various changes and modifications may be made without departing from the spirit and the scope of the inventions. For example and without limitation, the size or “wingspan” of aircraft 10 may be substantially any size to accommodate various payloads and equipment. Additionally, nothing is this description is meant to restrict the shape or configuration of the body 14. Nor is anything in this description intended to limit the number or arrangement of the portions 50-52 or the equipment contained therein. Aircraft 10 may be formed from substantially any suitable material including, but not limited to, composite materials for the ring wing 12, impeller 16 and body 14.

What is claimed is:

1. An aircraft comprising:
an airfoil which is generally ring shaped to form and aperture, wherein said airfoil includes a plurality of Coanda slots disposed along an exterior edge; and
an impeller which is rotatably coupled to a source of torque, said impeller being disposed within said aperture.

2. The aircraft of claim 1 further comprising:
a manifold which receives a pressurized gas; and
a plurality of electronic valve assemblies which are communicatively coupled to said manifold, wherein a unique one of said plurality of electronic valve assemblies is communicatively coupled to a unique one of each of said plurality of Coanda slots.

3. The aircraft of claim 2 further comprising a source of compressed gas which is communicatively coupled to said manifold.

4. The aircraft of claim 3 further comprising a controller which is coupled to said plurality of electronic valves, said source of compressed gas, and said source of torque, wherein said controller is effective to cause said impeller to rotate to force air past said airfoil and to cause said valves and source of compressed gas to emit a jet of said gas from said Coanda slots to entrain said air forced past said airfoil into downward thrust.

5. The aircraft of claim 1 further comprising a body portion which is coupled to said airfoil substantially beneath said airfoil, wherein said source of torque, said manifold, and said plurality of electronic valve assemblies are disposed within said body portion.

6. The aircraft of claim 5 wherein said body portion further comprises at least one cargo portion.

7. An aircraft comprising:
a body having a central portion and a pair of cargo portions which are coupled to said central portion on opposing sides;
an engine having an output shaft, wherein said engine is disposed within said central portion and said output shaft is directed up from the top of said body along a centerline;
an impeller which is coupled to said output shaft, wherein rotation of said output shaft is effective to cause said impeller to pull air toward said impeller thereby creating a first lifting force and to force air outward from said centerline;
a ring wing having a interior edge which is in the shape of a circle and defines an aperture and a exterior edge which defines an outer periphery of said ring wing, said airfoil being coupled to said body wherein said impeller is disposed within said aperture and said outwardly forced air is directed above and below said ring wing to create a second lifting force;
a plurality of equally spaced Coanda slots which are disposed within said ring wing along said exterior edge, wherein each of said plurality of Coanda slots is coupled to a manifold through a separate valve assembly; and
a controller which is disposed within said central portion of said body and which is operatively coupled to said engine and said valve assembly, wherein said controller selectively opens said valve assemblies to emit an amount of gas from said plurality of Coanda slots and divert said outwardly forced air downward to create a third lifting force.

8. The aircraft of claim 7 further comprising a top plate having a plurality of radially extending support struts, wherein said top plate is mounted to said body, said output shaft extending through a centrally disposed aperture in said top plate, and wherein said support struts are fixedly coupled to an underside of said ring wing.

9. The aircraft of claim 8 wherein said aircraft further comprises a generally circular manifold which is disposed within said body beneath said top plate and which is coupled to each of said valve assemblies of said plurality of Coanda slots.

10. The aircraft of claim 9 further comprising an air compressor which is coupled to said manifold, wherein said air compressor is further coupled to said controller to maintain said manifold within a certain pressure range.

11. The aircraft of claim 8 wherein said ring wing is mounted to said top plate relative to said impeller having a pitch angle between fifty and seventy-five percent of allowed pitch before wing stall.

12. The aircraft of claim 11 further comprising an input/output portion which is coupled to said controller, wherein said input/output portion is effective to receive control signals from a user.

13. The aircraft of claim 12 wherein said input/output portion is a radio frequency remote control assembly.

14. The aircraft of claim 12 wherein said input/output portion is a pendant controller having an extended communications bus coupled to said controller.

15. The aircraft of claim 11 wherein said ring wing has an outer diameter of approximately twelve feet.

16. A method for making an aircraft capable of vertical flight, said method comprising the steps of:
providing a body with an engine having an output shaft which is directed upwardly;
rotatably couplings an impeller to said output shaft upon the top of said body, wherein said impeller may be rotated to create a wash of air;
providing a ring wing having interior edges which define a central aperture and exterior edges which define an outer edge;
forming segmented Coanda slots along said outer edge of a ring wing, wherein each of said Coanda slots has a valve assembly which may be selectively opened and closed;
coupling said ring wing to said body wherein said impeller is located within said central aperture, thereby causing said ring wing to be disposed within said wash of air;
causing said impeller to rapidly rotate and create said wash of air which passes as a laminar flow having a certain boundary layer above and below said ring wing to create lift; and
causing said Coanda slots to discharge jets of gas at a certain velocity to redirect said laminar flowing air passing said ring wing to create additional lift.

17. The method of claim 16 further comprising the steps. of:
providing a source of gas; and
coupling said source of gas to said Coanda slots.

18. The method of claim 17 further comprising the step of landing said aircraft by causing said Coanda slots to stop discharging said jets of gas.

19. The method of claim 17 further comprising the step of increasing said velocity of said jets of gas being discharged from said Coanda slots to increase a height of said boundary layer of air being redirected to further increase lift.

20. The method of claim 17 further comprising the step of maneuvering said aircraft by selectively opening and closing said valves corresponding to at least one of said Coanda slots, thereby increasing and decreasing said velocity of said jets of air being emitted from said Coanda slots.
